(19) United States
(12) Patent Application Publication
(10) Pub. No.: US 2008/0088194 A1
(43) Pub. Date: Apr. 17, 2008

(54) Permanent-Magnet Rotor And A Method For Manufacturing A Permanent-Magnet Rotor

(75) Inventors: Jukka Jarvinen, Espoo (FI); Jukka Malmberg, Helsinki (FI)

Correspondence Address: BUCHANAN, INGERSOLL & ROONEY PC, POST OFFICE BOX 1404, ALEXANDRIA, VA, 22313-1404, US

(73) Assignee: ABB OY, Helsinki (FI)

(21) Appl. No.: 11/630,963

(22) PCT Filed: Jul. 4, 2005
(86) PCT No.: PCT/FI05/00311

§ 371 Date: Feb. 8, 2007

(30) Foreign Application Priority Data
Jul. 2, 2004 (FI) 20040931

(51) Int. Cl. H02K 1/27; H02K 1/28; H02K 15/03

(52) U.S. Cl. 310/156.23; 29/598; 310/156.48

(57) ABSTRACT

The object of the invention is a rotor for a permanent-magnet machine with an outer circumference curved towards the stator of the machine and permanent magnets fitted into openings arranged in the pole piece. According to the invention, the pole piece includes several parallel permanent magnets, leaving a neck of material at the edges of the pole piece outside the permanent magnets.

The object of the invention is a rotor for a permanent-magnet electrical machine according to the preamble part of claim 1 and a method for manufacturing a permanent-magnet rotor according to the preamble part of claim 9.

Permanent-magnet electrical machines have become significantly more common since efficient permanent magnets have entered the market. In particular, permanent-magnet synchronous machines have been used in many applications that have previously employed either squirrel-cage machines or direct current machines. In the rotors of permanent-magnet machines, permanent magnets are fitted either onto the surface of the rotor or embedded in the sheet core of the rotor, which is often manufactured of ferromagnetic sheets. Permanent magnets embedded in the rotor are placed either essentially circumferential to the rotor or in a V arrangement depending on the solution.

The manufacture of permanent-magnet machines involves problems caused by the permanent-magnet material. Permanent-magnet material is relatively fragile and must therefore be handled with care, particularly as the permanent magnets are very strong and attract the iron in the rotor sheet core with a great force. Another important factor is the design of the outer circumference of the magnetic pole, which affects the optimal distribution of the air gap flux. The intention is to create a magnetic flux in the air gap with a distribution that is as regular as possible, practically sinusoidal. Several suggestions for this exist, including the design of the outer circumference of the rotor's pole parts and the control of magnetic flux in the pole by arranging openings in it. The size of the permanent-magnet pieces also determines the techno-economical choices.

In large machines with a substantially high circumferential rotor speed, the centrifugal forces imposed on the poles and permanent magnets are great. However, at the same time care must be taken to maintain the optimality of the machine's electromagnetic properties. This means that the structure must be mechanically strong and the distribution of magnetic flux must be sinusoidal. Harmonic frequencies will cause noise and vibration in the machine.

The purpose of the present invention is to eliminate the problems described above and to develop a new permanent-magnet rotor that would be more preferable and economical in terms of manufacturing technology and more reliable in use. The rotor according to the invention is characterised by the features specified in the characteristics section of claim 1 and, correspondingly, the method according to the invention is characterised by the features specified in the characteristics section of claim 9. Some other preferred embodiments of the invention have the characteristics specified in the dependent claims.

The solution according to the invention makes it economical to manufacture machines with large permanent-magnet poles, as the permanent magnets of each pole can be formed of several permanent-magnet pieces in the lateral direction of the pole—that is, the direction of the rotor's rotation. The permanent magnets are rectangular and of a standard size, which makes them more economical and easy to handle. The outer surface of the pole will be shaped curvilinear as required by the dimensioning of the machine by cutting the magnetic sheet from which the pole sheet pack is manufactured, which is easier to cut. The fact that the part between the permanent magnets and the air gap is made of sheets with excellent magnetic properties means that magnetic losses are minimised and the flux is equally distributed. The mechanical structure is also robust in demanding applications and with great centrifugal forces.

According to a preferred embodiment of the invention, a support element is fitted between the parallel magnets of a single pole, interconnecting the pole cap and the sheet pack on the shaft side of the permanent magnet. The pole structure achieved with this solution remains mechanically strong and rigid. If the support element is a bar made of stainless steel, it will not have any distorting effect on the magnetic field.

In the following the invention will be described with the help of certain embodiments by referring to the enclosed drawings, where

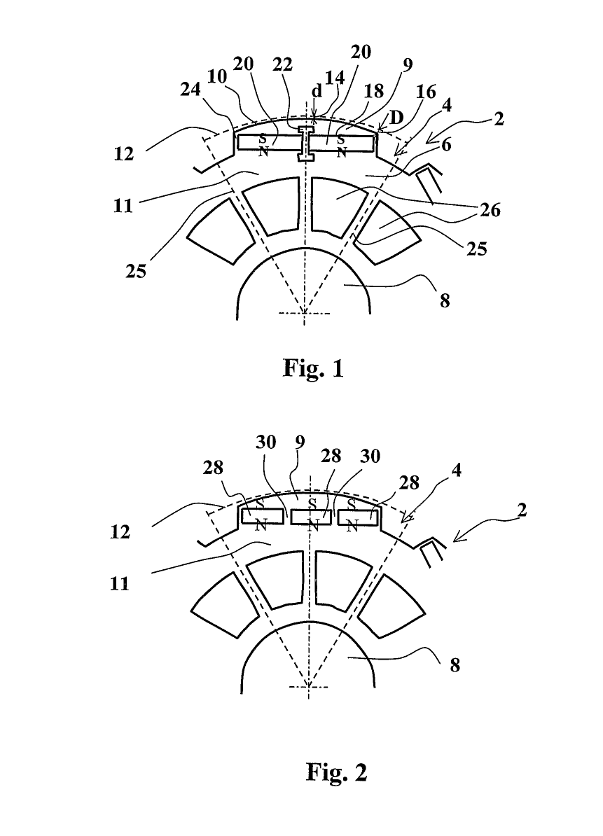

FIG. 1 illustrates the cross section of a rotor according to the invention,

FIG. 2 illustrates the cross section of a rotor according to a second embodiment of the invention, and

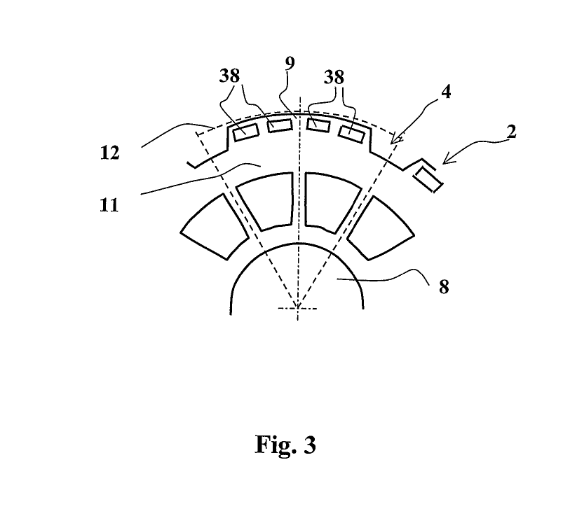

FIG. 3 illustrates the cross section of a rotor according to a third embodiment of the invention.

FIG. 1 illustrates the cross-section of one pole 4 within a rotor 2 according to the invention. The pole 4 comprises a rotor sheet pack 6 formed of layered ferromagnetic sheets. The sheets are cut in a well-known way so that there is a hole for the shaft 6 at the centre of the rotor sheet pack and the rotor pole is formed of a pole piece 9 with a curved outer circumference 10 and a rotor magnetic body 11 between the pole piece and the shaft. Preferably, the curvature of the pole's outer circumference differs from the curvature of the machine's air gap surface, which is circular and marked in the figure with the dashed line 12. The distance d between the centre 14 of the pole 4 and the air gap surface 12 is smaller than the distance D between the edge 16 of the pole and the air gap surface 12. The design of the pole piece affects the distribution of magnetic flux in the machine's air gap. The intention is to make the air gap flow as close to sinusoidal as possible, which reduces the machine's torque ripple and harmonic currents.

Openings 18 are die-cut in the rotor pole piece 9 and permanent-magnet pieces 20 are fitted into these so that one of the permanent magnet's magnetic poles, in this case the S pole, faces the air gap and the other magnetic pole, the N pole, faces the machine's shaft 8. This embodiment includes two parallel permanent magnets in the direction of the rotor's rotation. There can be several permanent magnetic pieces in the longitudinal or axial direction of the rotor, depending on the size of the machine. An I bar 22 of non-magnetic material, such as stainless steel, is installed between the parallel permanent-magnet pieces 20, extending into the rotor sheet pack both in the part of the permanent magnets facing the air gap—that is, the pole piece 9—and the part facing the shaft—that is, the magnetic body 11. The magnetic properties of a rotor pole of this design are excellent, as the leak of magnetic field between the S and N poles is reduced and the magnetic flux is directed into the air gap. In the case of a wide pole with several parallel permanent magnets, a neck of ferromagnetic sheet must be left between the permanent magnets due to factors of manufacturing technology, which makes the sheet more rigid and easier to handle during assembly of the sheet pack. The neck of material should be as narrow as possible to minimise its distorting effect on the magnetic field. There are necks of material 24 connecting the pole piece 9 and the magnetic body 11 on the edges of the pole piece at the locations of the permanent magnets. These hold the pole piece in place during manufacture and also in the completed machine. The width of the neck should be kept at the minimum required by mechanical rigidity in order to minimise stray magnetic fluxes. Once the rotor sheet pack 6 is assembled and fitted on the shaft 8, the permanent-magnet pieces 20 are placed into the openings 18 made for them and the steel bar 22 is inserted into grooves made for it. Finally, the space between the permanent magnets and the sheet pack required by the installation clearance is filled by a method such as resin injection or vacuum impregnation that locks the permanent magnets into place.

The rotor in the embodiment of FIG. 1 comprises six poles—that is, three pairs of poles—and the part between the radial dashed lines 25 forms one pole. There is a part at the edges of the pole piece 9 in each pole in which the machine's air gap is significantly larger than at the pole piece. The width and depth of this part outside the pole piece are an application-specific dimensioning issue. This can also be used for conveying cooling air in order to improve the efficiency of cooling. Likewise, the part between the poles and the shaft is often unnecessarily wide with regard to the electromagnetic properties of the electrical machine. To make this part of the rotor body narrower and the entire rotor lighter it is advantageous to make openings 26 in the rotor body. These openings can be used to convey cooling air.

FIGS. 2 and 3 illustrate certain other embodiments of the invention using the reference numbers of FIG. 1 as applicable. It should be understood in connection with all of the Figures that they only illustrate and describe the parts and features significant to the invention. Known solutions are applicable to other aspects of the construction of the rotor, as well as the stator and frame of the electrical machine.

Three parallel permanent-magnet pieces 28 are fitted into the rotor pole piece, and two adjacent pole pieces are separated by a neck of material 30 remaining in the sheets of the sheet pack. The effect of the neck distorting the magnetic field is preferably compensated by a thick pole piece providing a distribution of flux in the air gap that is as sinusoidal as possible. Similar to FIG. 1, the permanent-magnet pieces in this case are rectangular and there are several of them in sequence in the axial direction of the rotor.

The embodiment illustrated by FIG. 3 includes four parallel permanent-magnet pieces 32 embedded in the pole piece so that they are not in line with each other but form an angle with the adjacent permanent-magnet piece.

In the above the invention has been described with the help of a certain embodiment. However, the description should not be considered limiting; the embodiments of the invention may vary within the scope of the following claims.

1. A rotor for a permanent-magnet machine comprising at least two pole pieces formed of a sheet pack having a curved outer circumference facing the machine's stator, said sheet pack being fitted onto the shaft, and permanent magnets fitted in openings arranged in the pole piece and having a first and a second, opposite, magnetic pole, one magnetic pole of each permanent magnet essentially facing the circumference of the rotor and the other, opposite, magnetic pole essentially facing the rotor shaft, whereby a neck of material remains at the edges of the pole piece outside the permanent magnets, wherein each pole piece is fitted with at least two essentially parallel permanent magnets and wherein a support piece extending over the permanent magnets, essentially in the radial direction of the rotor, is arranged between the parallel magnets of each pole piece.

2. A rotor according to claim 1, wherein the support piece is formed by the neck of material in the sheet pack remaining between the permanent magnets.

3. A rotor according to claim 1, wherein the support piece is a steel bar extending to the parts of the pole inside and outside the permanent magnet.

4. A rotor according to claim 1, wherein the parallel magnets arranged in each pole piece are fitted essentially parallel to a secant connecting the corners of the opposite edges of each pole.

5. A rotor according to claim 1, wherein the parallel permanent magnets arranged in each pole piece are fitted oblique to each other.

6. A rotor according to claim 5, wherein the angle between parallel permanent magnets on the side of the rotor shaft is more than 180 degrees.

7. A rotor according to claim 1, wherein there is filling material between the permanent-magnet pieces and the sheet pack of the pole for keeping the permanent magnets in place.

8. A method for manufacturing a permanent-magnet rotor, said rotor comprising a sheet pack to be fitted onto the shaft of the machine, and at least two poles with a curved outer circumference facing the machine's stator being formed in the sheet pack, said method including openings to be formed in the rotor pole for fitting the permanent magnets, wherein at least two permanent magnets essentially parallel in the direction of the rotor's circumference are fitted into one pole and wherein the space remaining between the pole and the permanent magnets is filled with filler material to lock the permanent magnets, and wherein a support element is fitted between the permanent magnets and extends into the pole sheet pack in the radial direction of the rotor inside and outside the permanent magnets.

9. A method according to claim 8, wherein a neck of material connecting the pole cap and the inside part of the rotor is left between at least two permanent magnets.

10. A method according to claim 8, wherein the openings receiving the permanent magnets of one pole piece are arranged to be parallel to a secant of the pole piece or a tangent of the outer circumference of the pole piece.

11. A rotor according to claim 2, wherein the parallel magnets arranged in each pole piece are fitted essentially parallel to a secant connecting the corners of the opposite edges of each pole.

12. A rotor according to claim 11, wherein the parallel permanent magnets arranged in each pole piece are fitted oblique to each other.

13. A rotor according to claim 12, wherein the angle between parallel permanent magnets on the side of the rotor shaft is more than 180 degrees.

14. A rotor according to claim 2, wherein the parallel permanent magnets arranged in each pole piece are fitted oblique to each other.

15. A rotor according to claim 3, wherein the parallel permanent magnets arranged in each pole piece are fitted oblique to each other.

16. A method according to claim 9, wherein the openings receiving the permanent magnets of one pole piece are arranged to be parallel to a secant of the pole piece or a tangent of the outer circumference of the pole piece.
